(19) United States
(12) Patent Application Publication
(10) Pub. No.: US 2025/0329079 A1
(43) Pub. Date: Oct. 23, 2025

(54) CUSTOMIZATION ASSISTANT FOR TEXT-TO-IMAGE GENERATION

(71) Applicant: ADOBE INC., SAN JOSE, CA (US)

(72) Inventors: Yufan Zhou, San Jose, CA (US); Ruiyi Zhang, Palo Alto, CA (US); Jiuxiang Gu, Baltimore, MD (US); Tong Sun, San Jose, CA (US)

(21) Appl. No.: 18/637,914

(22) Filed: Apr. 17, 2024

(51) Int. Cl. G06T 11/60; G06T 9/00

(52) U.S. Cl. CPC G06T 11/60; G06T 9/00

(57) ABSTRACT

A method, apparatus, non-transitory computer readable medium, and system for image processing include obtaining an input image and a text prompt including an image modification request, generating a text response based on the input image and the text prompt, where the text response describes a modification to the input image corresponding to the image modification request, and generating a synthetic image based on the input image and an output embedding of a language generation model, where the synthetic image depicts the modification to the input image.

### BACKGROUND

The following relates generally to image processing, and more specifically to conversational image generation using a machine learning model. Image processing refers to the use of a computer to edit an image using an algorithm or a processing network. In some cases, image processing software can be used for various image processing tasks such as image restoration, image detection, image compositing, image editing, and image generation. For example, image generation includes the use of the machine learning model to generate an image based on a conditioning such as a text prompt or a reference image.

Conversation generation refers to creating human-like conversations using a machine learning model. Conversation generation is useful in interactive interfaces by providing contextually relevant responses to user inquiries and enhancing overall user experience. However, conventional models do not generate both a synthetic image and relevant responses to a prompt.

### SUMMARY

Aspects of the present disclosure provide a method and a system for customizing a text-to-image generation model. According to some aspects, the system includes an image encoder, a language generation model, and an image generation model. In one aspect, the image encoder is configured to encode an input image to obtain an image embedding. In one aspect, the language generation model is trained to generate a guidance embedding for the image generation model based on the image embedding of the input image and a text embedding of an input text prompt. The guidance embedding includes an element not explicitly described by the text prompt. In one aspect, the image generation model is trained to generate a synthetic image based on the image embedding of the input image and the guidance embedding generated by the language generation model, where the synthetic image includes the element. In one aspect, the language generation model generates a text response that describes and explains why the synthetic image is generated.

Aspects for a method, apparatus, non-transitory computer readable medium, and system for image processing include obtaining an input image and a text prompt including an image modification request. An aspect further includes generating, using a language generation model, a text response based on the input image and the text prompt, where the text response describes a modification to the input image corresponding to the image modification request. An aspect further includes generating, using an image generation model, a synthetic image based on the input image and an output embedding of the language generation model, where the synthetic image depicts the modification to the input image.

Aspects for a method, apparatus, non-transitory computer readable medium, and system for image processing include obtaining a training set including a training text prompt, a training text response, a training input image, and a training output image. An aspect further includes training, using the training set, a language generation model to generate a text response and a guidance embedding based on an input text prompt and an input image. An aspect further includes training, using the training set, an image generation model to generate a synthetic image based on the input image and the guidance embedding.

Aspects for an apparatus and system for image processing include at least one processor and at least one memory storing instructions executable by the at least one processor. An aspect further includes a language generation model comprising parameters stored in the at least one memory and trained to generate a text response based on an input image and a text prompt. An aspect further includes an image generation model comprising parameters stored in the at least one memory and trained to generate a synthetic image based on the input image and an output embedding of the language generation model.

### BRIEF DESCRIPTION OF THE DRAWINGS

FIG. 1 shows an example of an image processing system according to aspects of the present disclosure.

FIG. 2 shows an example of a method for customizing a text-to-image generation model according to aspects of the present disclosure.

FIG. 3 shows an example of a user interface of a customization assistance according to aspects of the present disclosure.

FIG. 4 shows an example of a customized text-to-image generation model according to aspects of the present disclosure.

FIG. 5 shows an example of an image generation based on a reference image according to aspects of the present disclosure.

FIG. 6 shows an example of a method for generating a synthetic image and a text response based on a text prompt and an input image according to aspects of the present disclosure.

FIG. 7 shows an example of an image processing apparatus according to aspects of the present disclosure.

FIG. 8 shows an example of a conversational image generation model according to aspects of the present disclosure.

FIG. 9 shows an example of a diffusion model according to aspects of the present disclosure.

FIG. 10 shows an example of a method for generating a synthetic image and a text response based on an output embedding according to aspects of the present disclosure.

FIG. 11 shows an example of a method for generating a synthetic image based on a reference image according to aspects of the present disclosure.

FIG. 12 shows an example of an image generation using a reference image according to aspects of the present disclosure.

FIG. 13 shows an example of a method for training the machine learning model according to aspects of the present disclosure.

FIG. 14 shows an example of a computing device according to aspects of the present disclosure.

### DETAILED DESCRIPTION

Aspects of the present disclosure provide a method and a system for customizing a text-to-image generation model (e.g., conversational image generation). According to some aspects, the system includes an image encoder, a language generation model, and an image generation model. In one aspect, the image encoder is configured to encode an input image to obtain an image embedding. In one aspect, the language generation model is trained to generate a guidance embedding for the image generation model based on the image embedding of the input image and an input text prompt. The guidance embedding includes an element not explicitly described by the text prompt. In one aspect, the image generation model is trained to generate a synthetic image based on the image embedding of the input image and the guidance embedding generated by the language generation model, where the synthetic image includes the element. In one aspect, the language generation model generates a text response that describes and explains why the synthetic image is generated.

According to some embodiments of the present disclosure, the system receives a set of user inputs that includes an input image depicting an element and a text prompt describing a condition for the input image. In some cases, the text prompt can be arbitrary, ambiguous, descriptive, interrogative, long, or short. Then, the language generation model is trained to infer an “intention” of the text prompt and generate an output embedding based on the input image and the text prompt. In some cases, the output embedding includes information about a new element that might not be explicitly described by the text prompt but is closely related to the text prompt. The output embedding is input into a guidance projection layer of the language generation model to generate a guidance embedding for an image generation model, where the guidance embedding includes global or semantic information of the element depicted in the input image and the new element. The image generation model further receives an image embedding of the input image, where the image embedding includes detailed information about the element depicted in the input image. The image generation model generates a synthetic image based on the image embedding and the guidance embedding.

In some embodiments, the output embedding is input into a language model head of the language generation model to generate a text response that describes the synthetic image and provides additional feedback (e.g., an answer) to the text prompt. In some cases, the prompt can be vague, and the text response can further explain or elaborate why the synthetic image is generated. In one aspect, the text response describes a modification to the input image depicted in the synthetic image. In some cases, the system provides a conversational ability, where the text response provides an additional user-friendly experience to a user.

A subfield in image processing relates to customizing pre-trained text-to-image generation models. Customized image generation models generate creative images that include a feature in an input image (e.g., a user-provided image). In some cases, conventional image generation models receive an input image and a text prompt to generate an output image. However, such models are unable to generate creative images based on arbitrary text prompts. For example, conventional image generation models are trained to generate images based on descriptive or directive text prompts. When provided with a text prompt having a certain degree of ambiguity or uncertainty, conventional models are unable to extract helpful information from the text prompt to generate an output image.

Conventional text-to-image generation models include an image encoder that encodes an input image to obtain an image embedding and a text encoder that encodes an input text prompt to obtain a text embedding. Then, the conventional models generate an output image based on the image embedding and the text embedding. However, by using the text encoder to encode information in the text prompt, the conventional models cannot learn the hidden meaning of the input text prompt. For example, the text encoders are trained to encode information that is explicitly described by the input text prompt. As a result, the conventional text-to-image generation models are unable to generate a synthetic image if the input text prompt is ambiguous.

In some cases, conventional approaches for customizing image generation include fine-tuning a pre-trained text-to-image generation model. For example, a conventional approach fine-tunes an entire diffusion model. For example, a conventional approach fine-tunes a cross-attention module of a UNet of the diffusion model. For example, a conventional approach reduces the number of parameters to be tuned to increase the efficiency of fine-tuning. For example, a conventional approach stabilizes the finetuning process by preserving a pair-wise neuron relationship of a pre-trained diffusion model.

In some cases, conventional approaches for customizing image generation focus on encoding the input text prompt to embeddings. For example, a conventional approach encodes the input text prompt into embedding vectors in an input space of a text encoder of a diffusion model. However, the optimization method used to obtain the embedding vectors is long and inefficient. To reduce the time cost, some conventional approaches focus on pre-trained image encoders which can map the input images into image embeddings. Image features generated from pre-trained image encoders are used to enhance the performance of customizing image generation because pre-trained image encoders can generate detailed information that may be challenging to capture in the input space of the pre-trained text encoder.

In some cases, conventional approaches include the use of apprenticeship learning to obtain an apprentice model (e.g., a customized generation model). In some cases, a conventional approach includes a language model configured to receive vision-language prompts to condition the image generation model. In some cases, a conventional approach trains a hyper-network of the image generation model to generate weights for a target model (e.g., a customized generation model).

Although many conventional approaches are used to customize text-to-image generation models, the conventional approaches fail to generate an output image when provided with a text prompt having a certain degree of ambiguity or uncertainty. In some cases, conventional models are unable to extract helpful information from the text prompt. Additionally, conventional models are unable to preserve the identity of an object (e.g., a person, animal, or object) depicted in the input image. Additionally, conventional models fail to provide a user-friendly experience by not providing additional explanations as to why the output image is being generated.

Accordingly, the present disclosure describes a method and a system that generates a synthetic image depicting a modification and a text response describing the modification based on an input image and an input text prompt. In one aspect, the synthetic image includes a new element not explicitly described by the text prompt. In one aspect, the identity of an element (e.g., person, animal, or object) depicted in the input image is preserved in the synthetic image. In one aspect, the text response includes additional feedback to the input text prompt and explains how and/or why the synthetic image has been modified.

According to some aspects, the language generation model is trained to generate a guidance embedding based on an input image and a text prompt. For example, the language generation model transforms an image embedding of the input image in a high-dimensional vector space into a projected image embedding in a low-dimensional vector space. Then, the language generation model generates an output embedding based on the projected image embedding and a text embedding of the text prompt. By generating the embeddings in the low-dimensional vector space, computational efficiency is increased and memory requirement is decreased.

In some embodiments, the language generation model transforms the output embedding to generate a guidance embedding that includes high-level semantic information of the input image and the text prompt in a high-dimensional vector space. The guidance embedding is further used in the image generation model to generate the synthetic image. In some embodiments, the language generation model further generates a text response that provides additional information or explains a modification in the synthetic image based on the output embedding.

According to some aspects, the image generation model is trained to generate the synthetic image based on the guidance embedding and the image embedding of the input image. For example, the image embedding captures fine-grained detailed features such as edges, textures, colors, shapes, patterns, contours, and intensity gradients of the element depicted in the input image. In contrast, the guidance embedding captures high-level semantic information about the input image and the text prompt. Accordingly, by combining the image embedding and the guidance embedding, the synthetic image includes both high-level information of the input image and low-level details of the input image. As a result, despite the modification, the identity of the element depicted in the input image is preserved in the synthetic image.

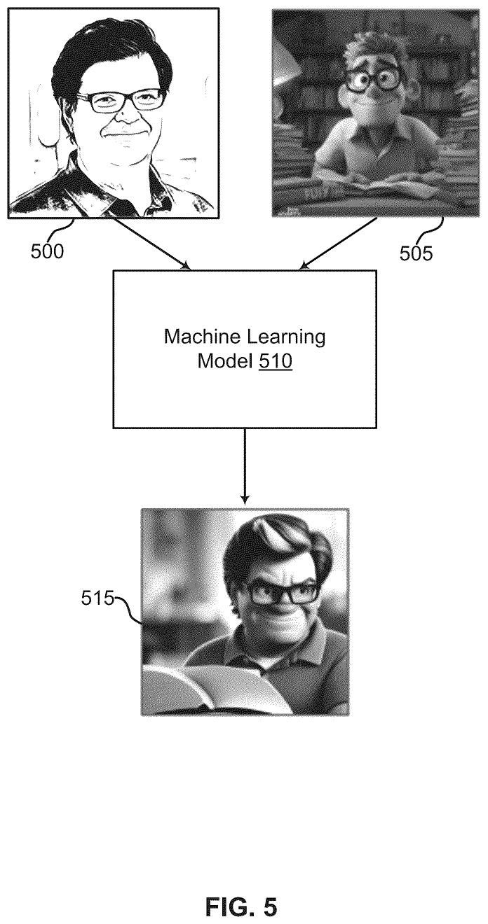

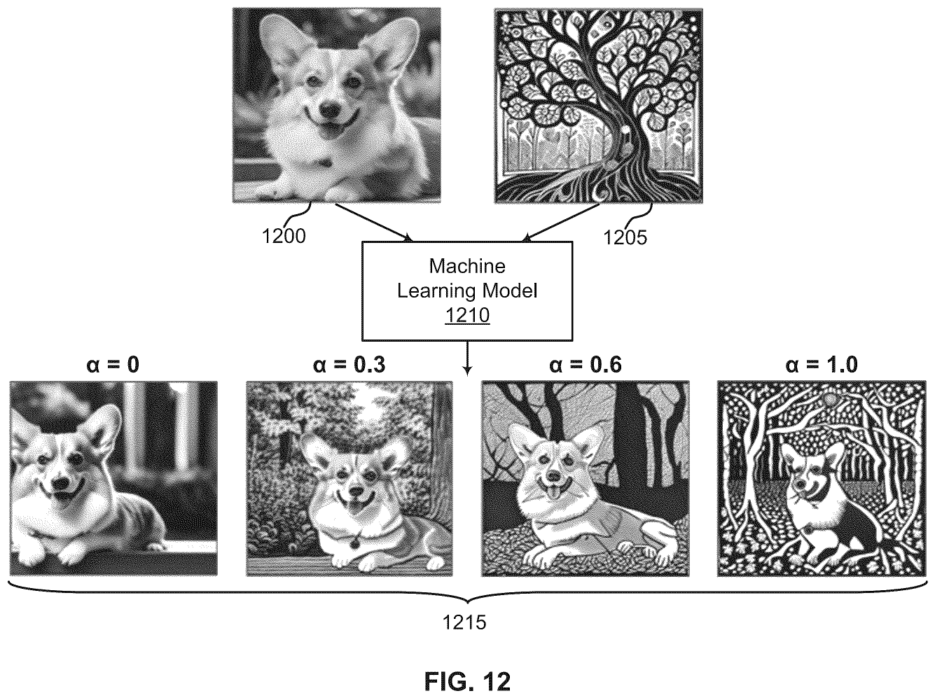

According to some aspects, the machine learning model (including the language generation model and the image generation model) can be used to further generate training output images to increase the training set. For example, the system can generate a synthetic image based on the input image and a reference image. As shown in at least FIGS. 5 and 12, the synthetic image can be used as a training output image in the training set. Accordingly, the time needed to create the training set can be significantly reduced.

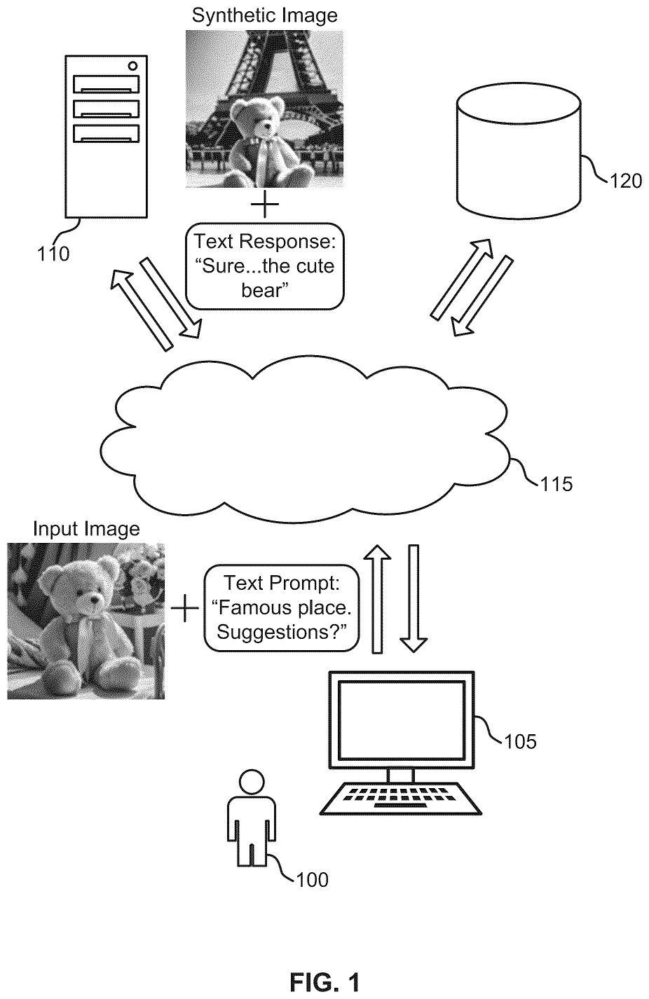

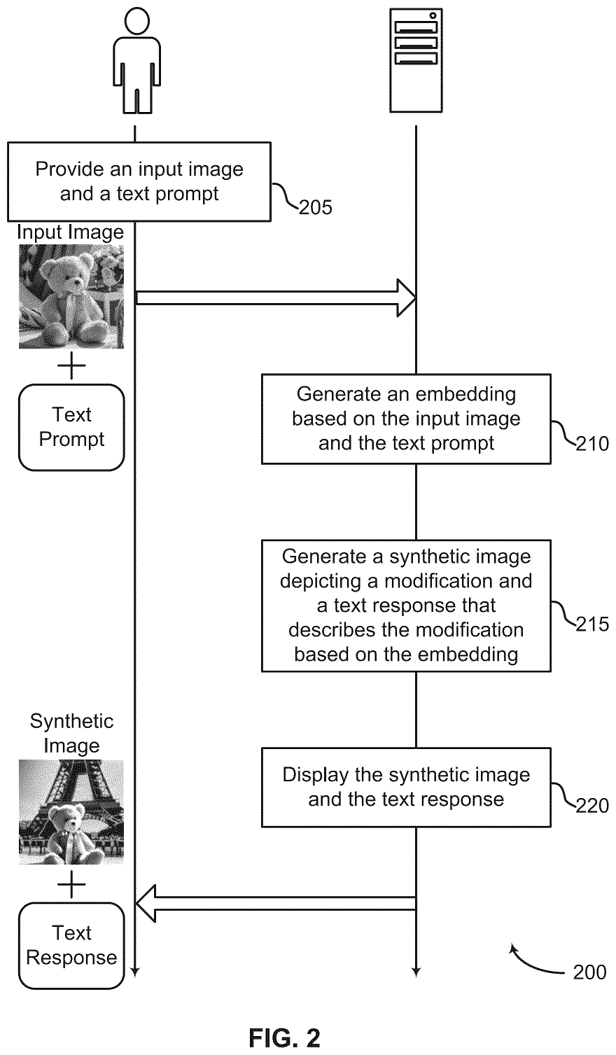

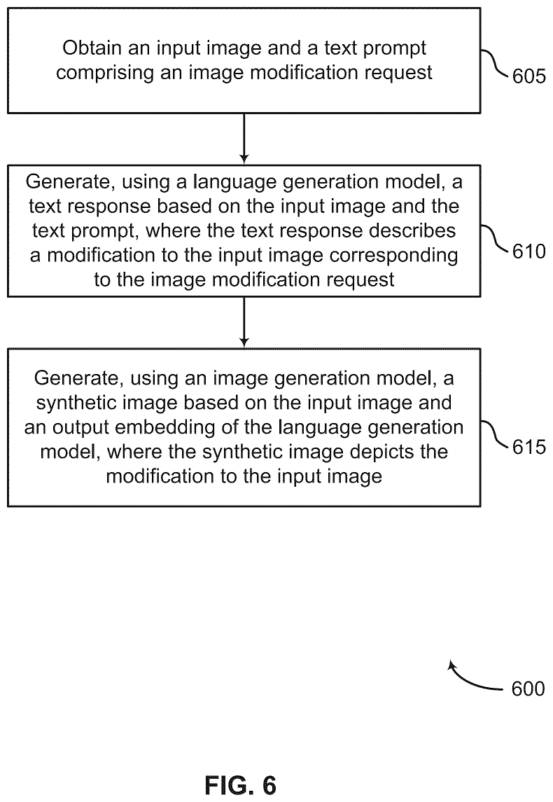

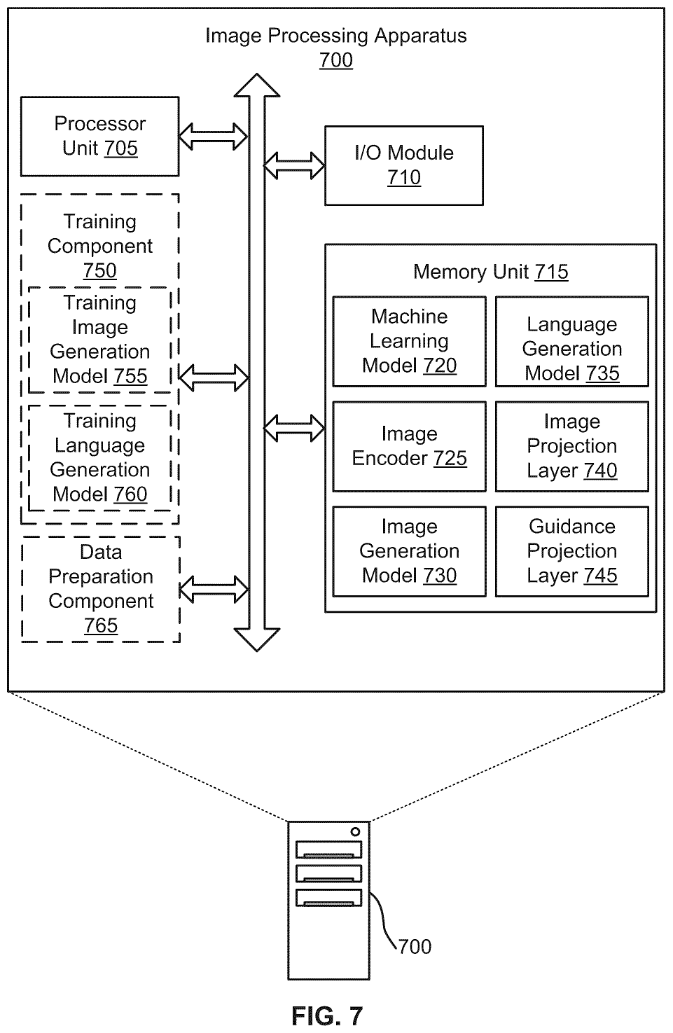

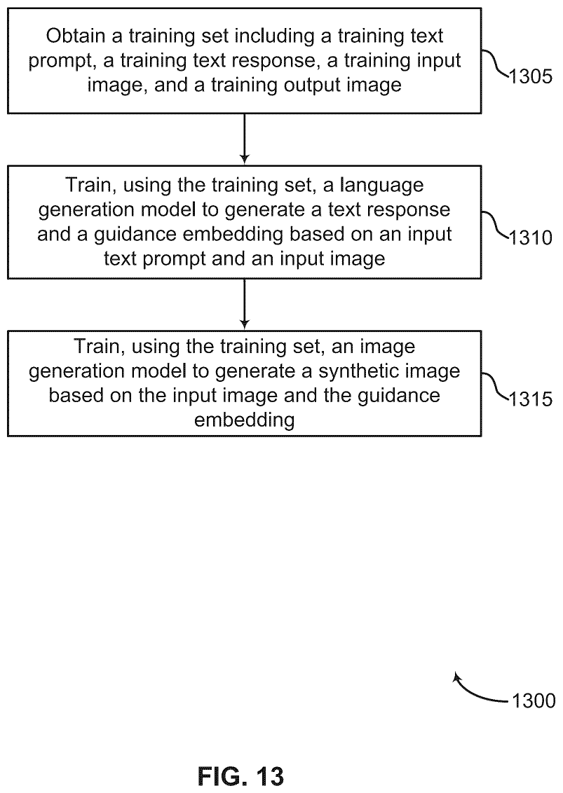

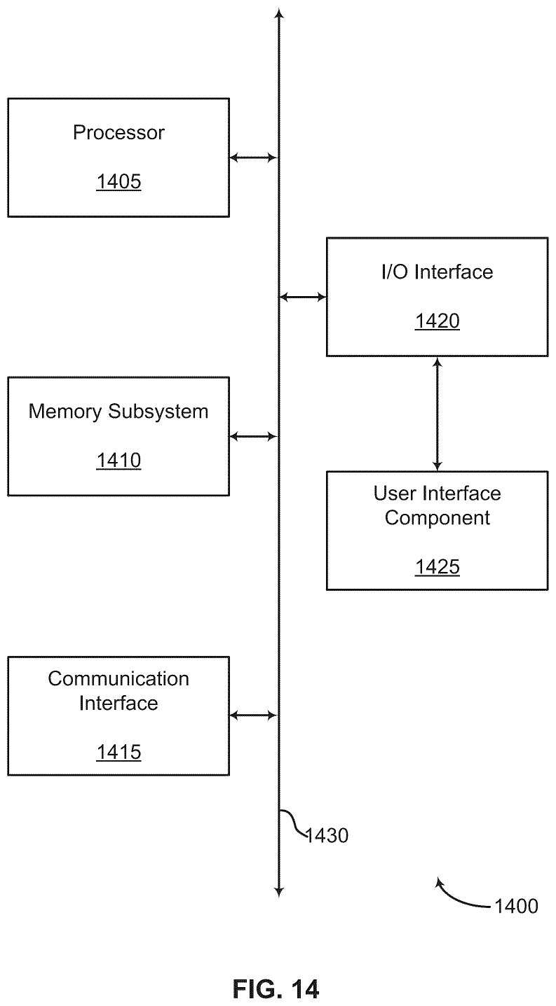

An example system of the inventive concept in image processing is provided with reference to FIGS. 1 and 14. An example application of the inventive concept in image processing is provided with reference to FIGS. 2-5. Details regarding the architecture of an image processing apparatus are provided with reference to FIGS. 7-9. An example of a process for image processing is provided with reference to FIGS. 6 and 10-12. A description of an example training process is provided with reference to FIG. 13.

Embodiments of the present disclosure include systems and methods that improve on conventional text-to-image generation models by generating synthetic images and corresponding text responses accurately, creatively, and efficiently. For example, a language generation model is trained to generate an output embedding in a low-dimensional vector space and then the output embedding is used to generate a synthetic image and a text response. As a result, the time required for generating the synthetic image is significantly reduced. Since the output embedding is generated by the language generation model (i.e., a generative model), the output embedding includes information about a new element that is not explicitly described by the text prompt. Accordingly, an image generation model can generate creative images based on the output embedding. By generating the synthetic image using an image embedding of the input image, the identity of the element depicted in the input image can be preserved in the synthetic image. In some cases, the images generated using the present system can be used as training images to further expand the training dataset. In some cases, the text response provides an interactive experience to a user.

### Customizing Text-to-Image Generation

In FIGS. 1-6, and 10-12, a method, apparatus, non-transitory computer readable medium, and system for image processing are described. An aspect includes obtaining an input image and a text prompt comprising an image modification request. An aspect further includes generating, using a language generation model, a text response based on the input image and the text prompt, where the text response describes a modification to the input image corresponding to the image modification request. An aspect further includes generating, using an image generation model, a synthetic image based on the input image and an output embedding of the language generation model, where the synthetic image depicts the modification to the input image.

Some examples of the method, apparatus, non-transitory computer readable medium, and system further include encoding, using an image encoder, the input image to obtain an image embedding, where the synthetic image is generated based on the image embedding. Some examples of the method, apparatus, non-transitory computer readable medium, and system further include transforming, using an image projection layer of the language generation model, the image embedding to obtain a projected image embedding, where the text response and the output embedding are based on the projected image embedding.

Some examples of the method, apparatus, non-transitory computer readable medium, and system further include transforming, using a guidance projection layer of the language generation model, the output embedding of the language generation model to obtain a guidance embedding, where the synthetic image is generated based on the guidance embedding. In some aspects, the language generation model is trained to generate a guidance embedding for the image generation model. In some aspects, the image generation model is trained to generate the synthetic image based on the guidance embedding.

Some examples of the method, apparatus, non-transitory computer readable medium, and system further include obtaining a reference image, where the synthetic image is generated based on the reference image. Some examples of the method, apparatus, non-transitory computer readable medium, and system further include generating a plurality of images by iteratively adjusting a parameter that balances the input image and the reference image.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 7.

Referring to FIG. 1, user 100 provides an input image depicting an object and a text prompt to image processing apparatus 110 via user device 105 and cloud 115. For example, the input image depicts a stuffed animal of a bear. For example, the text prompt is a question provided by user 100 that states “I want to generate an image for this bear at a famous place, can you give me some suggestions?” In response, image processing apparatus 110 generates a synthetic image and a corresponding text response. For example, the synthetic image depicts the bear in front of a landmark. Additionally, the text response provides an additional explanation that describes the modification in the synthetic image. For example, the text response states “Sure! Here's an image of the bear at the Eifel Tower in Paris, France. The iconic tower provides beautiful backdrop for the cute bear.” Image processing apparatus 110 displays the synthetic image and the text response to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

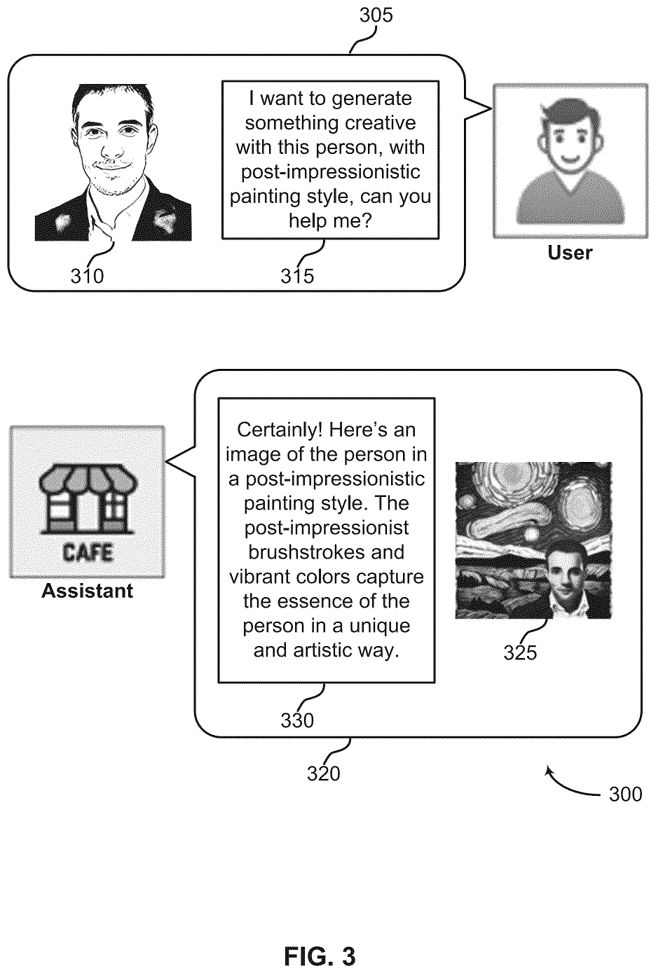

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2. User interface is an example of, or includes aspects of, the corresponding element described with reference to FIG. 3.

Image processing apparatus 110 is an example of, or includes aspects of, the corresponding element described with reference to FIG. 7. According to some aspects, image processing apparatus 110 includes a computer implemented network comprising a machine learning model, an image encoder, an image generation model, a language generation model, an image projection layer, and a guidance projection layer. Image processing apparatus 110 further includes a processor unit, a memory unit, an I/O module, a training component, and a data preparation component. In some cases, the training component includes a training image generation model and a training language generation model. In some embodiments, image processing apparatus 110 further includes a communication interface, user interface components, and a bus as described with reference to FIG. 14. Additionally, image processing apparatus 110 communicates with user device 105 and database 120 via cloud 115. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a ground truth image, a training foreground image, and a training background image. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for customizing a text-to-image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides an input image and a text prompt to the image processing apparatus (e.g., the image processing apparatus described with reference to FIGS. 1 and 7). For example, the input image depicts a stuffed animal of a bear and the text prompt is a user query to the image processing apparatus that states “I want to generate an image for this bear at a famous place, can you give me some suggestions?” The image processing apparatus generates an embedding based on the input image and the text prompt. For example, the embedding includes information about an element that might not be described by the text prompt. For example, the embedding may include information about the “Eiffel Tower” which is related to a famous place. Then, the image processing apparatus generates a synthetic image depicting the bear in front of the Eiffel Tower and a text response that explains why the synthetic image is generated in response to the user query. For example, the text response states “Sure! Here's an image of the bear at the Eifel Tower in Paris, France. The iconic tower provides beautiful backdrop for the cute bear.” The image processing apparatus displays the synthetic image and the text response to the user.

At operation 205, the system provides an input image and a text prompt. In some cases, the operations of this step refer to, or may be performed by, a user as described with reference to FIG. 1. For example, the user provides an image depicting a bear and a text prompt to image processing apparatus via a user interface (e.g., the user interface described with reference to FIG. 3) provided by the image processing apparatus on a user device (e.g., the user device described with reference to FIG. 1). For example, the text prompt states “I want to generate an image for this bear at a famous place, can you give me some suggestions?” In some cases, the user may provide a reference image to the image processing apparatus instead of the text prompt.

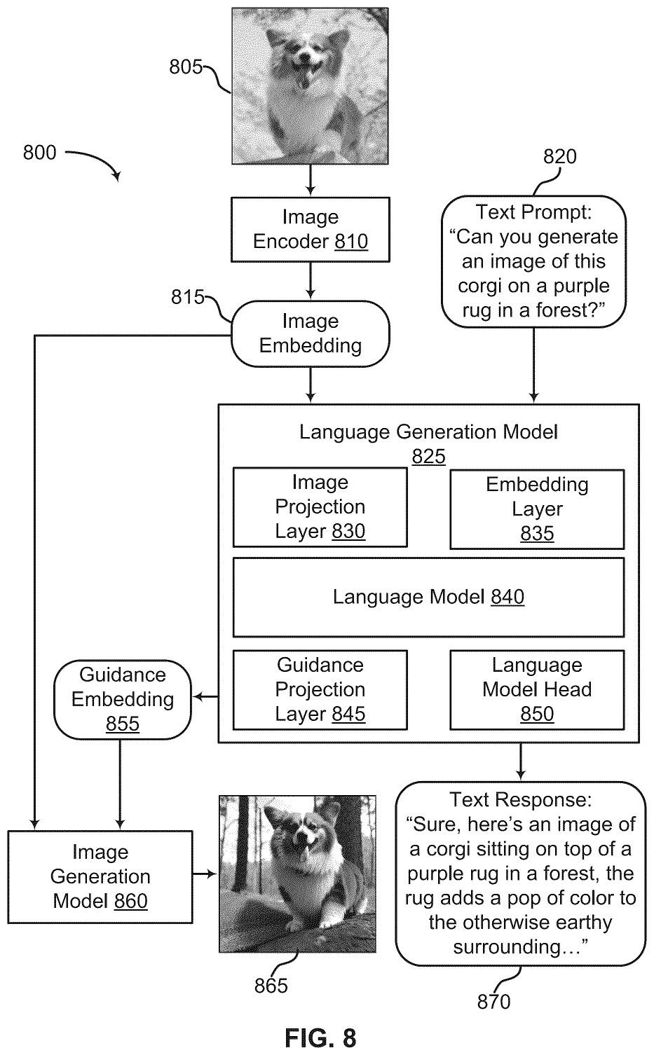

At operation 210, the system generates an embedding based on the input image and the text prompt. In some cases, the operations of this step refer to, or may be performed by, an image processing apparatus as described with reference to FIGS. 1 and 7. In some cases, the operations of this step refer to, or may be performed by, a language generation model as described with reference to FIGS. 7 and 8. For example, the language generation model is trained to generate an embedding based on the input image and the text prompt. In some cases, the embedding includes information about an additional element not explicitly described by the text prompt. For example, the embedding may include information about “Eiffel Tower” which is related to the “famous place” in the text prompt. In some aspects, the embedding further includes elements depicted in the input image such as “bear.” In some aspects, the embedding includes an element in the text prompt, an element in the input image, and an element not described by the text prompt but is related to the text prompt.

At operation 215, the system generates a synthetic image depicting a modification and a text response that describes the modification based on the embedding. In some cases, the operations of this step refer to, or may be performed by, an image processing apparatus as described with reference to FIGS. 1 and 7. In some cases, the operations of this step refer to, or may be performed by, an image generation model as described with reference to FIGS. 7 and 8. In some cases, the operations of this step refer to, or may be performed by, a language generation model as described with reference to FIGS. 7 and 8.

In some aspects, the language generation model transforms the embedding to obtain a guidance embedding. In some cases, the guidance embedding includes global (or high-level) semantic information of the synthetic image to be generated. For example, the guidance embedding includes semantic information such as the stuffed animal of the bear and the Eiffel Tower (from the embedding). In some embodiments, an image encoder is configured to generate an image embedding based on the input image. In one aspect, the image embedding captures low-level details of the input image. For example, low-level details include edges, textures, colors, shapes, patterns, contours, intensity gradients, etc. In some embodiments, the image generation model receives the guidance embedding and the image embedding to generate the synthetic image. Accordingly, the synthetic image depicts a modification to the input image, where the identity of the entity (e.g., the bear) is preserved in the synthetic image despite the modification.

In some aspects, the language generation model generates a text response describing the modification depicted in the synthetic image. For example, a language model head of the language generation model receives the embedding and generates the text response. The text response states “Sure! Here's an image of the bear at the Eifel Tower in Paris, France. The iconic tower provides beautiful backdrop for the cute bear.” Accordingly, the image processing apparatus provides a much more user-friendly experience to the user.

At operation 220, the system displays the synthetic image and the text response. In some cases, the operations of this step refer to, or may be performed by, an image processing apparatus as described with reference to FIGS. 1 and 7. In some cases, the operations of this step refer to, or may be performed by, a user device as described with reference to FIG. 1. In some cases, the operations of this step refer to, or may be performed by, a user interface as described with reference to FIG. 3. In some cases, the synthetic image and the text response are displayed on a user device via a user interface of the image processing apparatus and cloud. In some cases, the user can further provide feedback and request to re-generate the synthetic image and the text response.

FIG. 3 shows an example of a user interface of a customization assistance according to aspects of the present disclosure. The example shown includes user interface 300, user input 305, and system output 320. In one aspect, user input 305 includes input image 310 and text prompt 315. In one aspect, system output 320 includes synthetic image 325 and text response 330.

Referring to FIG. 3, user input 305 is provided to user interface 300. For example, user input 305 includes input image 310 that depicts a man and text prompt 315 that describes what the user wants to do with the input image 310. For example, text prompt 315 states “I want to generate something creative with this person, with post-impressionistic painting style, can you help me?” Compared to conventional text prompts that are directive and descriptive, text prompt 315 is broad, vague, and uncertain. Nevertheless, user interface 300 processes user input 305 and generates system output 320.

For example, system output 320 includes synthetic image 325 that depicts an image feature that aligns with the user request, and text response 330 that describes the changes to input image 310 depicted in synthetic image 325. For example, text response 330 states “Certainly! Here's an image of the person in a post-impressionistic painting style. The post-impressionist brushstrokes and vibrant colors capture the essence of the person in a unique and artistic way.” Text response 330 further describes the modifications to input image 310. For example, text response 330 explains that synthetic image 325 includes post-impressionist brushstrokes and vibrant colors that represent the painting style. Additionally, although synthetic image 325 is a painting, the person depicted in synthetic image 325 and the person depicted in input image 310 are the same (e.g., identity is preserved).

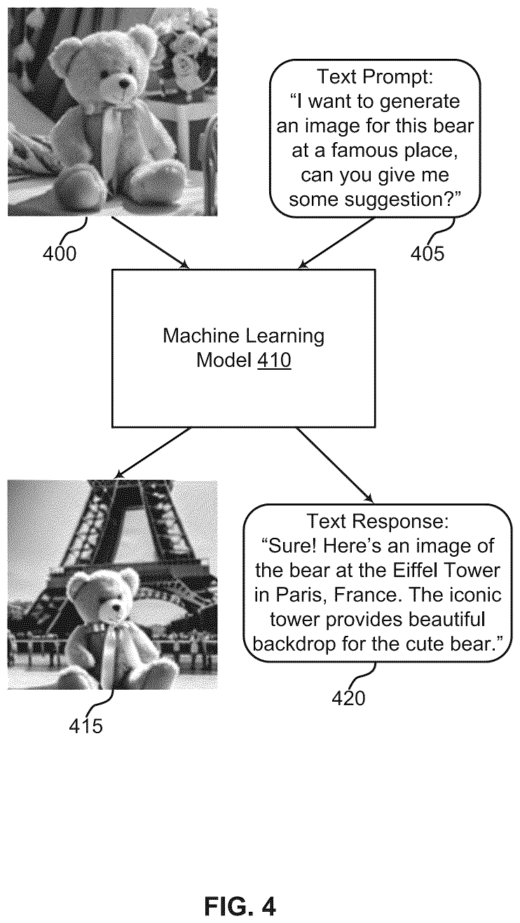

Input image 310 is an example of, or includes aspects of, the corresponding element described with reference to FIGS. 4, 5, 8, and 12. Text prompt 315 is an example of, or includes aspects of, the corresponding element described with reference to FIGS. 4, 8, and 9. Synthetic image 325 is an example of, or includes aspects of, the corresponding element described with reference to FIGS. 4, 5, 8, and 12. Text response 330 is an example of, or includes aspects of, the corresponding element described with reference to FIGS. 4 and 8.

FIG. 4 shows an example of a customized text-to-image generation model according to aspects of the present disclosure. The example shown includes input image 400, text prompt 405, machine learning model 410, synthetic image 415, and text response 420.

Referring to FIG. 4, machine learning model 410 receives input image 400 and text prompt 405 to generate synthetic image 415 and text response 420. For example, input image 400 depicts a stuffed animal of a bear sitting next to a miniature table. For example, text prompt 405 states “I want to generate an image for this bear at a famous place, can you give me some suggestions?” Then, machine learning model 410 analyzes text prompt 405 and input image 400 to obtain useful information. For example, a language generation model of machine learning model 410 obtains a projected image embedding of input image 400 and a text embedding of text prompt 405. Then, the language generation model generates an output embedding based on the projected image embedding and the text embedding. The output embedding includes useful information such as the semantics of the object to be generated (e.g., the bear) and elements that are correlated to a famous place.

In some embodiments, machine learning model 410 transforms the output embedding into a guidance embedding, where the guidance embedding includes the information in the output embedding in a high-dimensional vector space. Then, an image generation model of machine learning model 410 uses the guidance embedding and an image embedding of input image 400 to generate synthetic image 415. For example, synthetic image 415 depicts the original object/entity (e.g., the bear) of input image 400 and the Eiffel Tower in the background, where the Eiffel Tower represents a suggestion of a famous place described in text prompt 405.

In one aspect, the language generation model generates text response 420 based on the output embedding. For example, text response 420 states “Sure! Here's an image of the bear at the Eifel Tower in Paris, France. The iconic tower provides beautiful backdrop for the cute bear.” Text response 420 answers the user query in text prompt 405. Additionally, text response 420 provides further explanation or elaboration as to why the Eiffel Tower is the suggested famous place. Accordingly, the interaction between a user and the machine learning model 410 is enhanced.

Input image 400 is an example of, or includes aspects of, the corresponding element described with reference to FIGS. 3, 5, 8, and 12. Text prompt 405 is an example of, or includes aspects of, the corresponding element described with reference to FIGS. 3, 8, and 9. Machine learning model 410 is an example of, or includes aspects of, the corresponding element described with reference to FIGS. 5, 7, 8, and 12. Synthetic image 415 is an example of, or includes aspects of, the corresponding element described with reference to FIGS. 3, 5, 8, and 12. Text response 420 is an example of, or includes aspects of, the corresponding element described with reference to FIGS. 3 and 8.

FIG. 5 shows an example of an image generation based on a reference image according to aspects of the present disclosure. The example shown includes input image 500, reference image 505, machine learning model 510, and synthetic image 515.

Referring to FIG. 5, machine learning model 510 receives input image 500 and reference image 505 to generate synthetic image 515. For example, input image 500 depicts a man with glasses and a unique hairstyle. For example, reference image 505 depicts a cartoon character. Then, machine learning model 510 analyzes input image 500 and reference image 505 to obtain useful semantic information. For example, machine learning model 510 extracts global semantics (e.g., the man with glasses, blue t-shirt, etc.) of input image 500. Additionally, machine learning model 510 extracts visual features (such as the cartoon character) from reference image 505. Then, machine learning model 510 combines the two features and uses the combined feature as global semantics to guide the image generation. For example, the combined feature (e.g., similar to the guidance embedding described with reference to FIG. 4) is in a high-dimensional vector space. Then, an image generation model of machine learning model 510 uses the combined feature (also referred to as a combined embedding) and an image embedding of input image 500 to generate synthetic image 515. For example, synthetic image 515 depicts the original person (e.g., the man with glasses and unique hairstyle) of input image 500 in a cartoonish style (suggested based on reference image 505). In some embodiments, machine learning model 510 further generates a text response that explains or provides additional details on why the synthetic image is being generated. For example, the text response states “The image depicts the man in a cartoonish style based on the reference image.”

Input image 500 is an example of, or includes aspects of, the corresponding element described with reference to FIGS. 3, 4, 8, and 12. Reference image 505 is an example of, or includes aspects of, the corresponding element described with reference to FIG. 12. Machine learning model 510 is an example of, or includes aspects of, the corresponding element described with reference to FIGS. 4, 7, 8, and 12. Synthetic image 515 is an example of, or includes aspects of, the corresponding element described with reference to FIGS. 3, 4, 8, and 12.

FIG. 6 shows an example of a method 600 for generating a synthetic image and a text response based on a text prompt and an input image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, the system (e.g., image processing apparatus described with reference to FIGS. 1 and 7) generates a synthetic image and a text response based on an input image and an input text prompt. In some embodiments, the synthetic image is generated based on the input image and a reference image. In one aspect, the synthetic image preserves the identity of the object (e.g., a person, animal, etc.) from the input image with modifications described by the text prompt. In one aspect, the text response provides an explanation or elaboration on the synthetic image.

At operation 605, the system obtains an input image and a text prompt comprising an image modification request. In some cases, the operations of this step refer to, or may be performed by, a machine learning model as described with reference to FIGS. 4, 5, 7, 8, and 12. In some cases, for example, a user provides the input image and the text prompt to the machine learning model of the system. For example, the input image depicts an object, entity, or person. In some cases, for example, the text prompt can be arbitrary, ambiguous, descriptive, interrogative, long, short, or a combination thereof.

At operation 610, the system generates, using a language generation model, a text response based on the input image and the text prompt, where the text response describes a modification to the input image corresponding to the image modification request. In some cases, the operations of this step refer to, or may be performed by, a language generation model as described with reference to FIGS. 7 and 8. In some embodiments, the system extracts semantic features from the input image and the textual information from the text prompt to generate an output embedding. In one aspect, the output embedding includes information about the image to be generated (e.g., the synthetic image), where the information includes a modification to the input image. Then, the language generation model generates the text response based on the output embedding to describe the modification depicted in the synthetic image. Further detail on generating the text response is described with reference to FIG. 8.

In some cases, for example, modification refers to a change or altercation of visual appearances between the input image and the output image (e.g., the synthetic image). For example, a modification can refer to adding a new element to the input image, performing a stylistic transformation to the input image, or adjusting the pose of an element in the input image. In some cases, visual changes can be applied to the color, shape, size, texture, and/or composition of the input image.

In some cases, the modification is not explicitly described by the text prompt and is generated by the language generation model. For example, if the text suggests “have this person in front of a famous place,” then the language generation model can identify and generate an embedding that includes information about the famous place. For example, the embedding may include information on the Eiffel Tower, Pyramid, Great Wall, Statute of Liberty, Grand Canyon, etc. Accordingly, even when provided with a vague text prompt, the language generation model is able to generate specific elements that align with the user intention described in the vague text prompt.

At operation 615, the system generates, using an image generation model, a synthetic image based on the input image and an output embedding of the language generation model, where the synthetic image depicts the modification to the input image. In some cases, the operations of this step refer to, or may be performed by, an image generation model as described with reference to FIGS. 7 and 8. In some cases, the system transforms the output embedding into a guidance embedding, where the guidance embedding includes information about the image to be generated in a high-dimensional vector space. In some embodiments, the image generation model receives the guidance embedding and an image embedding of the input image to generate the synthetic image. Further detail on generating the synthetic image is described with reference to FIG. 8.

In some cases, for example, an embedding is a numerical representation of words, sentences, documents, or images in a vector space. The embedding is used to encode semantic meaning, relationships, and context of the words, sentences, documents, or images where the encoding can be processed by a machine learning model. For example, an image embedding captures complex visual features in a high-dimensional vector space. For example, a text embedding includes semantic relationships between words or tokens in a low-dimensional vector space.

In some cases, for example, a vector space refers to the space formed by vectors representing data points. Vector space provides a framework for representing and manipulating data (in the form of vectors), computing distances between vectors, and transforming input data for complex relationships. The dimensionality of the vector space is determined by the number of features in the feature vector. For example, if each data point has three features (e.g., length, width, and height), the vector space is three-dimensional. In some cases, a joint vector space includes a high-dimensional vector space and a low-dimensional vector space.

### Image Processing Architecture

In FIGS. 1, 7-9, and 14, an apparatus and system for image processing include at least one processor and at least one memory storing instructions executable by the at least one processor. An aspect further includes a language generation model comprising parameters stored in the at least one memory and trained to generate a text response based on an input image and a text prompt. An aspect further includes an image generation model comprising parameters stored in the at least one memory and trained to generate a synthetic image based on the input image and an output embedding of the language generation model.

Some examples of the apparatus and system further include an image encoder comprising parameters stored in the at least one memory and configured to encode the input image to obtain an image embedding. Some examples of the apparatus and system further include an image projection layer comprising parameters stored in the at least one memory and configured to transform an image embedding of the input image to obtain a projected image embedding.

Some examples of the apparatus and system further include a guidance projection layer comprising parameters stored in the at least one memory and configured to transform the output embedding of the language generation model to obtain a guidance embedding. In some aspects, the image generation model comprises a diffusion model.

FIG. 7 shows an example of an image processing apparatus 700 according to aspects of the present disclosure. The example shown includes image processing apparatus 700, processor unit 705, I/O module 710, memory unit 715, training component 750, and data preparation component 765. In one aspect, memory unit 715 includes machine learning model 720, image encoder 725, image generation model 730, language generation model 735, image projection layer 740, and guidance projection layer 745. In one aspect, training component 750 includes training image generation model 755 and training language generation model 760.

According to some embodiments of the present disclosure, image processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 14.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 14. The user interface is an example of, or includes aspects of, the corresponding element described with reference to FIGS. 1, 3 and 14.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

In one aspect, memory unit 715 includes machine learning model 720, image encoder 725, image generation model 730, language generation model 735, image projection layer 740, and guidance projection layer 745. Memory unit 715 is an example, of, or includes aspects of, the memory subsystem described with reference to FIG. 14.

According to some aspects, machine learning model 720 includes image encoder 725, image generation model 730, language generation model 735, image projection layer 740, and guidance projection layer 745. In some cases, machine learning model 720 is a computational algorithm, model, or system designed to recognize patterns, make predictions, or perform a specific task (for example, image processing) without being explicitly programmed. According to some aspects, machine learning model 720 is implemented as software stored in memory unit 715 and executable by processor unit 705, as firmware, as one or more hardware circuits, or as a combination thereof.

According to some embodiments of the present disclosure, machine learning model 720 includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model 720 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model 720 includes machine learning parameters. Machine learning parameters, also known as model parameters or weights, are variables that provide behavior and characteristics of machine learning model 720. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow machine learning model 720 to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model 720 includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model 720 includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, machine learning model 720 obtains an input image and a text prompt. In some examples, machine learning model 720 obtains a reference image, where the synthetic image is generated based on the reference image. Machine learning model 720 is an example of, or includes aspects of, the corresponding element described with reference to FIGS. 4, 5, 8, and 12.

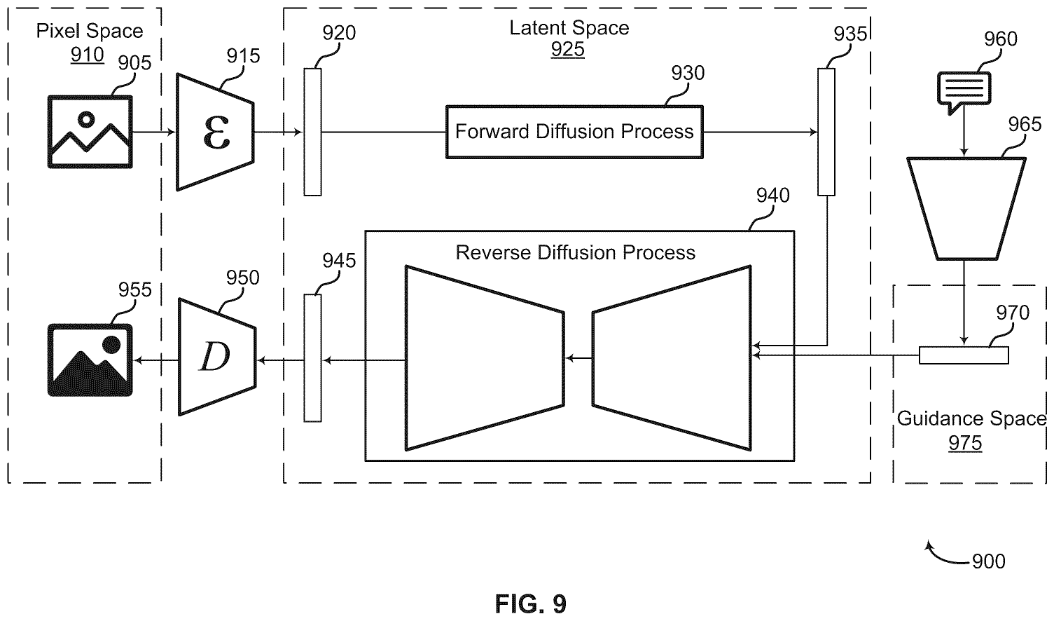

According to some aspects, image encoder 725 is implemented as software stored in memory unit 715 and executable by processor unit 705, as firmware, as one or more hardware circuits, or as a combination thereof. According to some aspects, image encoder 725 encodes the input image to obtain an image embedding, where the synthetic image is generated based on the image embedding. According to some aspects, image encoder 725 comprises parameters stored in the at least one memory and configured to encode the input image to obtain an image embedding. Image encoder 725 is an example of, or includes aspects of, the corresponding element described with reference to FIGS. 8 and 9.

According to some aspects, image generation model 730 is implemented as software stored in memory unit 715 and executable by processor unit 705, as firmware, as one or more hardware circuits, or as a combination thereof. According to some aspects, image generation model 730 generates a synthetic image based on the input image and an output embedding of language generation model 735, where the synthetic image depicts the modification to the input image. In some examples, image generation model 730 generates a set of images by iteratively adjusting a parameter that balances the input image and the reference image. In some aspects, the image generation model 730 is trained to generate the synthetic image based on the guidance embedding.

According to some aspects, image generation model 730 adds noise to the training output image to obtain a noisy image. In some examples, image generation model 730 performs a reverse diffusion process on the noisy image using the image generation model 730. Further detail on the reverse diffusion process is described with reference to FIG. 9.

According to some aspects, image generation model 730 comprises parameters stored in the at least one memory and trained to generate a synthetic image based on the input image and an output embedding of the language generation model 735. In some aspects, the image generation model 730 includes a diffusion model. Image generation model 730 is an example of, or includes aspects of, the corresponding element described with reference to FIG. 8. Image generation model 730 is an example of, or includes aspects of, the diffusion model described with reference to FIG. 9.

According to some aspects, language generation model 735 is implemented as software stored in memory unit 715 and executable by processor unit 705, as firmware, as one or more hardware circuits, or as a combination thereof. In one aspect, language generation model 735 includes image projection layer 740 and guidance projection layer 745.

According to some aspects, language generation model 735 includes natural language processing (NLP). NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models that make soft, probabilistic decisions based on attaching real-valued weights to input features. In some cases, these models express the relative probability of multiple answers.

According to some aspects, language generation model 735 generates a text response based on the input image and the text prompt, where the text response describes a modification to the input image. In some aspects, the language generation model 735 is trained to generate a guidance embedding for the image generation model 730. According to some aspects, language generation model 735 comprises parameters stored in the at least one memory and trained to generate a text response based on an input image and a text prompt. Language generation model 735 is an example of, or includes aspects of, the corresponding element described with reference to FIG. 8.

According to some aspects, image projection layer 740 is implemented as software stored in memory unit 715 and executable by processor unit 705, as firmware, as one or more hardware circuits, or as a combination thereof. In one aspect, image projection layer 740 transforms the image embedding to obtain a projected image embedding, where the text response and the output embedding are based on the projected image embedding.

According to some aspects, image projection layer 740 comprises parameters stored in the at least one memory and configured to transform an image embedding of the input image to obtain a projected image embedding. Image projection layer 740 is an example of, or includes aspects of, the corresponding element described with reference to FIG. 8.

According to some aspects, guidance projection layer 745 is implemented as software stored in memory unit 715 and executable by processor unit 705, as firmware, as one or more hardware circuits, or as a combination thereof. In one aspect, guidance projection layer 745 transforms the output embedding of the language generation model 735 to obtain a guidance embedding, where the synthetic image is generated based on the guidance embedding.

According to some aspects, guidance projection layer 745 comprises parameters stored in the at least one memory and configured to transform the output embedding of the language generation model 735 to obtain a guidance embedding. Guidance projection layer 745 is an example of, or includes aspects of, the corresponding element described with reference to FIG. 8.

According to some aspects, training component 750 is implemented as software stored in memory unit 715 and executable by processor unit 705, as firmware, as one or more hardware circuits, or as a combination thereof. In one aspect, training component 750 includes training image generation model 755 and training language generation model 760.

According to some embodiments, training component 750 is implemented as software stored in a memory unit and executable by a processor in a processor unit of a separate computing device, as firmware in a separate computing device, as one or more hardware circuits of the separate computing device, or as a combination thereof. In some examples, training component 750 is part of another apparatus other than image processing apparatus 700 and communicates with the image processing apparatus 700. In some examples, training component 750 is part of image processing apparatus 700.

According to some aspects, training component 750 trains, using the training set, language generation model 735 to generate a text response and a guidance embedding based on an input text prompt and an input image. In some examples, training component 750 trains, using the training set, image generation model 730 to generate a synthetic image based on the input image and the guidance embedding.

In some examples, training component 750 calculates a language loss including a first term based on the training text response and a second term based on the training output image, where the language generation model 735 is trained based on the language loss. In some examples, training component 750 computes an image loss based on the training output image and the training input image, where the image generation model 730 is trained based on the image loss.

According to some aspects, training image generation model 755 is implemented as software stored in memory unit 715 and executable by processor unit 705, as firmware, as one or more hardware circuits, or as a combination thereof. According to some embodiments, training image generation model 755 is implemented as software stored in a memory unit and executable by a processor in a processor unit of a separate computing device, as firmware in a separate computing device, as one or more hardware circuits of the separate computing device, or as a combination thereof. In some examples, training image generation model 755 is part of another apparatus other than image processing apparatus 700 and communicates with the image processing apparatus 700. In some examples, training image generation model 755 is part of image processing apparatus 700.

According to some aspects, training image generation model 755 generates the training output image based on the training input image. In some examples, training image generation model 755 obtains a reference image. In some examples, training image generation model 755 generates a set of training output images based on the training input image and the reference image, where the training set includes the set of training output images.

According to some aspects, training language generation model 760 is implemented as software stored in memory unit 715 and executable by processor unit 705, as firmware, as one or more hardware circuits, or as a combination thereof. According to some embodiments, training language generation model 760 is implemented as software stored in a memory unit and executable by a processor in a processor unit of a separate computing device, as firmware in a separate computing device, as one or more hardware circuits of the separate computing device, or as a combination thereof. In some examples, training language generation model 760 is part of another apparatus other than image processing apparatus 700 and communicates with the image processing apparatus 700. In some examples, training language generation model 760 is part of image processing apparatus 700.

According to some aspects, training language generation model 760 generates the training text prompt based on the training input image. In some examples, training language generation model 760 generates the training text response based on the training text prompt.

According to some aspects, data preparation component 765 is implemented as software stored in memory unit 715 and executable by processor unit 705, as firmware, as one or more hardware circuits, or as a combination thereof. According to some embodiments, data preparation component 765 is implemented as software stored in a memory unit and executable by a processor in a processor unit of a separate computing device, as firmware in a separate computing device, as one or more hardware circuits of the separate computing device, or as a combination thereof. In some examples, data preparation component 765 is part of another apparatus other than image processing apparatus 700 and communicates with the image processing apparatus 700. In some examples, data preparation component 765 is part of image processing apparatus 700.

According to some aspects, data preparation component 765 obtains a training set including a training text prompt, a training text response, a training input image, and a training output image. According to some aspects, data preparation component 765 obtains a plurality of preliminary images. According to some aspects, data preparation component 765 filters the plurality of preliminary images based on the training output image to obtain the training input image

FIG. 8 shows an example of a conversational image generation model according to aspects of the present disclosure. The example shown includes machine learning model 800, input image 805, image encoder 810, image embedding 815, text prompt 820, language generation model 825, guidance embedding 855, image generation model 860, synthetic image 865, and text response 870. In one aspect, language generation model 825 includes image projection layer 830, embedding layer 835, language model 840, guidance projection layer 845, and language model head 850.

Referring to FIG. 8, machine learning model 800 generates synthetic image 865 based on input image 805 depicting an object and text prompt 820 describing a conditioning. In some cases, synthetic image 865 includes a feature described or not described by text prompt 820. In one aspect, machine learning model 800 is able to understand and process declarative and interrogative text prompts. In some cases, text prompt 820 may be ambiguous or unclear. Machine learning model 800 is able to infer the intent of the user based on text prompt 820 and generate the synthetic image having a feature that relates to text prompt 820. In some embodiments, machine learning model 800 generates text response 870 that provides additional information or explains why synthetic image 865 is generated.

According to some aspects, machine learning model 800 includes image encoder 810 (e.g., pre-trained image encoder [symbol] ), language generation model 825 (e.g., multi-modal large language model represented as [symbol] ), and image generation model 860 (e.g., represented as [symbol] ). In one embodiment, image encoder 810 encodes input image 805 to obtain image embedding 815. For example, input image 805 depicts a corgi. In some aspects, image embedding 815 captures features and contents (such as shapes, textures, and patterns) of input image 805 in vector representation in a high-dimensional vector space. In one aspect, text prompt 820 is a query that states “Can you generate an image of this corgi on a purple rug in a forest?”

In an embodiment, language generation model 825 receives image embedding 815 and text prompt 820 to generate guidance embedding 855. For example, image projection layer 830 of language generation model 825 transforms image embedding 815 to generate a projected image embedding. In some cases, the projected image embedding is in a low-dimensional vector space that can be processed by language model 840. Additionally, embedding layer 835 of language generation model 825 generates a text embedding based on text prompt 820. In one aspect, the text embedding is in the same low-dimensional vector space that can be processed by language model 840. In one embodiment, language model 840 receives the projected image embedding and the text embedding to generate an output embedding.

In some cases, language model 840 generates two output embeddings: a first output embedding e; and a second output embedding s; based on the projected image embedding and the text embedding. In some cases, the two output embeddings include an inference of a user intention based on input image 805 and text prompt 820. In some cases, the second output embedding sⱼ is provided to guidance projection layer 845 of language generation model 825 to generate guidance embedding 855. In one aspect, guidance embedding 855 includes global semantic information in a high-dimensional vector space. For example, based on input image 805 and text prompt 820, guidance embedding 855 may include high-level semantic information such as corgi, purple rug, forest, etc. In some embodiments, the first output embedding eᵢ and the second output embedding s; are the same output embedding.

According to some embodiments, image generation model 860 generates synthetic image 865 based on image embedding 815 and guidance embedding 855. For example, image embedding 815 captures fine-grained detailed features such as edges, textures, colors, shapes, patterns, contours, and intensity gradients of the object (e.g., corgi) depicted in input image 805. In contrast, guidance embedding 855 captures high-level semantic information of input image 805 and text prompt 820. Accordingly, by combining image embedding 815 and guidance embedding 855, synthetic image 865 includes both high-level information of input image 805 and low-level details (such as identity) of input image 805. In one aspect, synthetic image 865 can be generated using the following equation:

$${z}^{′} = Softmax ( \frac{{Q}_{z} {K}_{H}^{T}}{\sqrt{d}} ) {V}_{H} + Softmax ( \frac{{Q}_{z} {K}_{ℰ}^{T}}{\sqrt{d}} ) {V}_{ℰ} , \qquad ( 1 )$$

where d is a scaling factor in the attention mechanism, z and z′ are intermediate features generated by the U-Net of image generation model 860 (e.g., the diffusion model described with reference to FIG. 9), Q_{z} is the query value calculated based on intermediate feature z, K_{H} and V_{H} are key and value, respectively, calculated based on guidance embedding 855 generated from guidance projection layer 845 of language generation model 825, and K [symbol] and V [symbol] are key and value, respectively, calculated based on image embedding 815 generated from image encoder 810.

According to some embodiments, language generation model 825 generates text response 870 based on the output embedding. For example, language model head 850 of language generation model 825 receives the output embedding from language model 840 to generate text response 870. In one aspect, text response 870 provides additional explanation or elaboration on synthetic image 865. For example, text response 870 states “Sure, here's an image of a corgi sitting on top of a purple rug in a forest, the rug adds a pop of color to the otherwise earthy surrounding.” Text response 870 provides an answer to text prompt 820 (e.g., a user query) and an explanation of the modification depicted in synthetic image 865.

Machine learning model 800 is an example of, or includes aspects of, the corresponding element described with reference to FIGS. 4, 5, 7, and 12. Input image 805 is an example of, or includes aspects of, the corresponding element described with reference to FIGS. 3-5, and 12. Image encoder 810 is an example of, or includes aspects of, the corresponding element described with reference to FIGS. 7 and 9. Text prompt 820 is an example of, or includes aspects of, the corresponding element described with reference to FIGS. 3, 4, and 9.

Language generation model 825 is an example of, or includes aspects of, the corresponding element described with reference to FIG. 7. Image projection layer 830 is an example of, or includes aspects of, the corresponding element described with reference to FIG. 7. Guidance projection layer 845 is an example of, or includes aspects of, the corresponding element described with reference to FIG. 7.

Image generation model 860 is an example of, or includes aspects of, the corresponding element described with reference to FIG. 7. Synthetic image 865 is an example of, or includes aspects of, the corresponding element described with reference to FIGS. 3-5, and 12. Text response 870 is an example of, or includes aspects of, the corresponding element described with reference to FIGS. 3 and 4.

FIG. 9 shows an example of a diffusion model 900 according to aspects of the present disclosure. The example shown includes diffusion model 900, original image 905, pixel space 910, image encoder 915, original image feature 920, latent space 925, forward diffusion process 930, noisy feature 935, reverse diffusion process 940, denoised image feature 945, image decoder 950, output image 955, text prompt 960, text encoder 965, guidance feature 970, and guidance space 975.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 900 may take an original image 905 (e.g., input image described with reference to FIGS. 3-5, 8, and 12) in a pixel space 910 as input and apply an image encoder 915 to convert original image 905 into original image feature 920 in a latent space 925. Then, a forward diffusion process 930 gradually adds noise to the original image feature 920 to obtain noisy feature 935 (also in latent space 925) at various noise levels.

Next, a reverse diffusion process 940 (e.g., a U-Net ANN) gradually removes the noise from the noisy feature 935 at the various noise levels to obtain the denoised image feature 945 in latent space 925. In some examples, denoised image feature 945 is compared to the original image feature 920 at each of the various noise levels, and parameters of the reverse diffusion process 940 of the diffusion model are updated based on the comparison. Finally, an image decoder 950 decodes the denoised image feature 945 to obtain an output image 955 in pixel space 910. In some cases, an output image 955 is generated at each of the various noise levels. The output image 955 can be compared to the original image 905 to train the reverse diffusion process 940. In some cases, output image 955 refers to the synthetic image (e.g., described with reference to FIGS. 3, 4, 5, and 8).

In some cases, image encoder 915 and image decoder 950 are pre-trained prior to training the reverse diffusion process 940. In some examples, image encoder 915 and image decoder 950 are trained jointly, or the image encoder 915 and image decoder 950 are fine-tuned jointly with the reverse diffusion process 940.

The reverse diffusion process 940 can also be guided based on a text prompt 960, or another guidance prompt, such as an image, a layout, a style, a color, a segmentation map, etc. The text prompt 960 can be encoded using a text encoder 965 (e.g., a multimodal encoder) to obtain guidance feature 970 in guidance space 975. The guidance feature 970 can be combined with the noisy feature 935 at one or more layers of the reverse diffusion process 940 to ensure that the output image 955 includes content described by the text prompt 960. For example, guidance feature 970 can be combined with the noisy feature 935 using a cross-attention block within the reverse diffusion process 940. In some cases, text prompt 960 refers to the corresponding element described with reference to FIGS. 3, 4, 8, and 9.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 960) describing content to be included in a generated image. For example, a user may provide the prompt “I want to generate something creative with this person, with post-impressionistic painting style, can you help me?” In some examples, guidance can be provided in a form other than text, such as via an image, a sketch, a color, a style, or a layout. The system converts text prompt 960 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 900 generates an image based on the noise map and the conditional guidance vector.

A diffusion process can include both a forward diffusion process 930 for adding noise to an image (e.g., original image 905) or features (e.g., original image feature 920) in a latent space 925 and a reverse diffusion process 940 for denoising the images (or features) to obtain a denoised image (e.g., output image 955). The forward diffusion process 930 can be represented as q(xₜ|xₜ₋₁), and the reverse diffusion process 940 can be represented as p(xₜ₋₁|xₜ). In some cases, the forward diffusion process 930 is used during training to generate images with successively greater noise, and a neural network is trained to perform the reverse diffusion process 940 (e.g., to successively remove the noise).

In an example forward diffusion process 930 for a latent diffusion model (e.g., diffusion model 900), the diffusion model 900 maps an observed variable x₀ (either in a pixel space 910 or a latent space 925) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 940. During the reverse diffusion process 940, the diffusion model 900 begins with noisy data x_{T}, such as a noisy image and denoises the data to obtain the p(xₜ₋₁|xₜ). At each step t−1, the reverse diffusion process 940 takes xₜ, such as the first intermediate image, and t as input. Here, t represents a step in the sequence of transitions associated with different noise levels, The reverse diffusion process 940 outputs xₜ₋₁, such as the second intermediate image iteratively until x_{T} is reverted back to x₀, the original image 905. The reverse diffusion process 940 can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 2 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 3 )$$

where p(x_{T})=N (x_{T}; 0, I) is the pure noise distribution as the reverse diffusion process 940 takes the outcome of the forward diffusion process 930, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space 925 as input and a generated data \tilde{x} is mapped back into the pixel space 910 from the latent space 925 as output. In some examples, x₀ represents an original input image with low image quality, latent variables x₁, . . . , x_{T} represent noisy images, and \tilde{x} represents the generated image with high image quality.

A diffusion model 900 may be trained using both a forward diffusion process 930 and a reverse diffusion process 940. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 930 in N stages. In some cases, the forward diffusion process 930 is a fixed process where Gaussian noise is successively added to an image. In latent diffusion models, the Gaussian noise may be successively added to features (e.g., original image feature 920) in a latent space 925.

At each stage n, starting with stage N, a reverse diffusion process 940 is used to predict the image or image features at stage n−1. For example, the reverse diffusion process 940 can predict the noise that was added by the forward diffusion process 930, and the predicted noise can be removed from the image to obtain the predicted image. In some cases, an original image 905 is predicted at each stage of the training process.

The training component (e.g., training component described with reference to FIG. 7) compares predicted image (or image features) at stage n−1 to an actual image (or image features), such as the image at stage n−1 or the original input image. For example, given observed data x, the diffusion model 900 may be trained to minimize the variational upper bound of the negative log-likelihood −log p_{θ}(x) of the training data. The training component then updates parameters of the diffusion model 900 based on the comparison. For example, parameters of a U-Net may be updated using gradient descent. Time-dependent parameters of the Gaussian transitions can also be learned.

Image encoder 915 is an example of, or includes aspects of, the corresponding element described with reference to FIGS. 7 and 8. Text prompt 960 is an example of, or includes aspects of, the corresponding element described with reference to FIGS. 3, 4, and 8.

### Image Generation

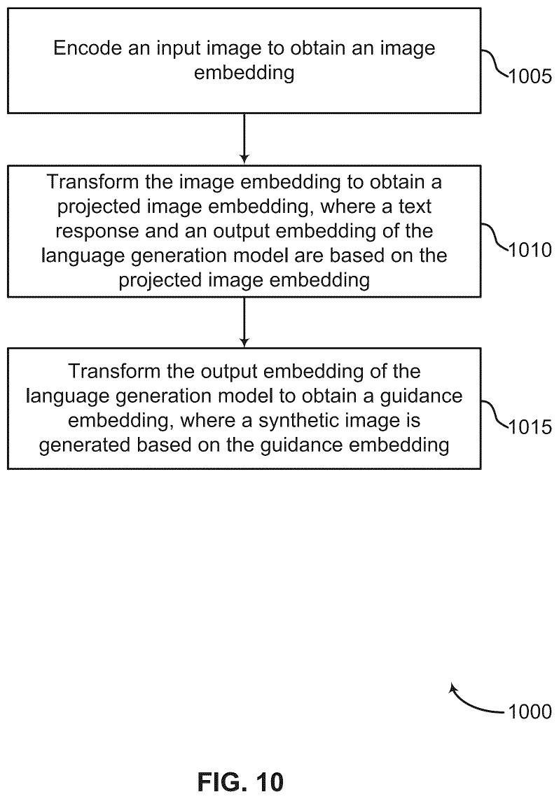

In FIGS. 10-12, a method, apparatus, non-transitory computer readable medium, and system for image processing are described. An aspect includes obtaining an input image and a text prompt. An aspect further includes generating, using a language generation model, a text response based on the input image and the text prompt, where the text response describes a modification to the input image. An aspect further includes generating, using an image generation model, a synthetic image based on the input image and an output embedding of the language generation model, where the synthetic image depicts the modification to the input image.

Some examples of the method, apparatus, non-transitory computer readable medium, and system further include encoding, using an image encoder, the input image to obtain an image embedding, where the synthetic image is generated based on the image embedding. Some examples of the method, apparatus, non-transitory computer readable medium, and system further include transforming, using an image projection layer of the language generation model, the image embedding to obtain a projected image embedding, where the text response and the output embedding are based on the projected image embedding.

Some examples of the method, apparatus, non-transitory computer readable medium, and system further include transforming, using a guidance projection layer of the language generation model, the output embedding of the language generation model to obtain a guidance embedding, where the synthetic image is generated based on the guidance embedding. In some aspects, the language generation model is trained to generate a guidance embedding for the image generation model. In some aspects, the image generation model is trained to generate the synthetic image based on the guidance embedding.

Some examples of the method, apparatus, non-transitory computer readable medium, and system further include obtaining a reference image, where the synthetic image is generated based on the reference image. Some examples of the method, apparatus, non-transitory computer readable medium, and system further include generating a plurality of images by iteratively adjusting a parameter that balances the input image and the reference image.

FIG. 10 shows an example of a method 1000 for generating a synthetic image and a text response based on an output embedding according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system encodes an input image to obtain an image embedding. In some cases, the operations of this step refer to, or may be performed by, an image encoder as described with reference to FIGS. 7-9. For example, the image embedding captures visual features and contents (such as shapes, textures, and patterns) of the input image in vector representation in a high-dimensional vector space. In some cases, the image embedding captures semantic information of the input image. For example, semantic information may include classifying objects (such as a person, animal, vehicle, or any other relevant entities) depicted in the input image.

At operation 1010, the system transforms the image embedding to obtain a projected image embedding, where a text response and an output embedding of the language generation model are based on the projected image embedding. In some cases, the operations of this step refer to, or may be performed by, an image projection layer as described with reference to FIGS. 7 and 8. For example, the projected image embedding is a reduced vector representation of the input image in a low-dimensional vector space. By transforming the image embedding into a projected image embedding, the language generation model can easily process the projected image embedding.

According to some aspects, operations and processing in low-dimensional vector space are computationally less intensive compared to those in high-dimensional vector space. In one aspect, the projected image embedding still retains important information about the input image despite having a reduced dimensionality. In some aspects, by reducing the dimensionality of the of the image embedding, the projected image embedding contains less noise or irrelevant details in the data. As a result, the machine learning model can achieve increased generalization to new, unseen data.

At operation 1015, the system transforms the output embedding of the language generation model to obtain a guidance embedding, where a synthetic image is generated based on the guidance embedding. In some cases, the operations of this step refer to, or may be performed by, a guidance projection layer as described with reference to FIGS. 7 and 8. In some embodiments, the language generation model generates the output embedding based on the projected image embedding of the input image and a text embedding of the text prompt. In one aspect, the output embedding is represented in the low-dimensional vector space. A guidance projection layer of the language generation model transforms the output embedding into a guidance embedding, where the guidance embedding is represented in a high-dimensional vector space. In one aspect, the guidance embedding includes global semantic information of the input image and an element not explicitly described by the text prompt. By generating the synthetic image based on the guidance embedding, the synthetic image includes visual features from the input image and new elements described by the text prompt.

According to some aspects, the image generation model generates the synthetic image based on the guidance embedding and the image embedding of the input image. In one aspect, the image embedding includes detail features such as edges, textures, colors, shapes, patterns, contours, and intensity gradients of an object depicted in the input image. By using both the guidance embedding and the image embedding of the input image, the synthetic image depicts a modification to the input image conditioned by the text prompt and preserves the identity of the object in the input image.

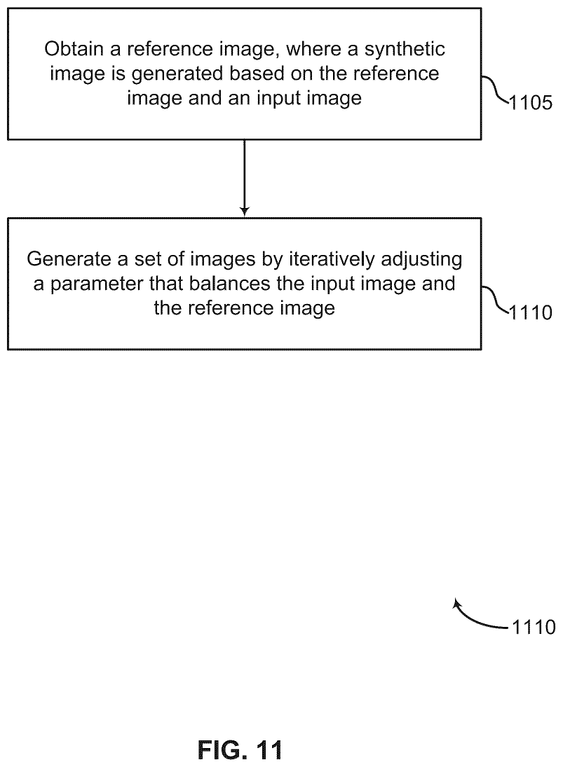

FIG. 11 shows an example of a method 1100 for generating a synthetic image based on a reference image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, the machine learning model of the system can generate synthetic images based on an input image and a reference image. For example, the reference image may depict a feature such as style, color, or composition. The machine learning model analyzes the features and combines the feature with the input image (or an embedding of the input image) to generate an output embedding. The output embedding includes global semantic information of the input image and a feature of the reference image. In one embodiment, an image generation model of the machine learning model generates the synthetic image based on the output embedding. In one embodiment, the image generation model generates the synthetic image based on the output embedding and the image embedding of the input image, where the identity of an object depicted in the input image is preserved in the synthetic image.

At operation 1105, the system obtains a reference image, where a synthetic image is generated based on the reference image and an input image. In some cases, the operations of this step refer to, or may be performed by, a machine learning model as described with reference to FIGS. 4, 5, 7, 8, and 12. In some cases, for example, the reference image is retrieved from a database (e.g., the database described with reference to FIG. 1). In some cases, for example, a user provides the reference image to the system. The reference image may depict a feature such as style, color, or composition. Further detail on generating the synthetic image based on the reference image and the input image is described with reference to FIGS. 5 and 12.

At operation 1110, the system generates a set of images by iteratively adjusting a parameter that balances the input image and the reference image. In some cases, the operations of this step refer to, or may be performed by, a machine learning model as described with reference to FIGS. 4, 5, 7, 8, and 12. In some cases, the operations of this step refer to, or may be performed by, an image generation model as described with reference to FIGS. 7 and 8. For example, by adjusting a parameter α, the image generation model can generate different synthetic images based on the input image and the reference image. Further detail regarding generating synthetic images based on adjusting a parameter is described with reference to FIG. 12.

FIG. 12 shows an example of an image generation using a reference image according to aspects of the present disclosure. The example shown includes input image 1200, reference image 1205, machine learning model 1210, and synthetic image 1215.

Referring to FIG. 12, machine learning model 1210 generates synthetic image 1215 based on input image 1200 and reference image 1205. For example, input image 1200 depicts a dog with a mix of brown and white fur. Reference image 1205 depicts a black-and-white line drawing of a tree. Synthetic image 1215 For example, synthetic image 1215 includes a plurality of images, where each of the plurality of images depicts a balanced feature of input image 1200 and reference image 1205 based on a parameter α. For example, synthetic image 1215 can be generated by:

$$\tilde{x} = 𝒢 ( ℰ ( x ) , αℱ ( w ) + ( 1 - α ) ℱ ( x ) ) , \qquad ( 4 )$$

where \tilde{x} represents synthetic image 1215, x represents input image 1200, w represents reference image 1205, and a is a hyper-parameter. In some cases, for example, reference image 1205 is obtained from the database (e.g., the database described with reference to FIG. 1) or generated using a pre-trained image generation model based on a text prompt.

As shown in FIG. 12, when parameter α=0, machine learning model 1210 generates synthetic image 1215 with no features depicted in reference image 1205. When parameter α=0.3, machine learning model 1210 generates synthetic image 1215 having colors depicted in input image 1200 and semi-line drawings from reference image 1205. When parameter α=0.6, machine learning model 1210 generates synthetic image 1215 having mostly black-and-white line drawing of the dog. When parameter α=1, machine learning model 1210 generates synthetic image 1215 having a black-and-white line drawing of the dog and trees in the background similar to the style depicted in reference image 1205. Despite the changes in parameter α, machine learning model 1210 generates synthetic image 1215 having different styles and depicting the same dog from input image 1200.

Input image 1200 is an example of, or includes aspects of, the corresponding element described with reference to FIGS. 3-5, and 8. Reference image 1205 is an example of, or includes aspects of, the corresponding element described with reference to FIG. 5. Machine learning model 1210 is an example of, or includes aspects of, the corresponding element described with reference to FIGS. 4, 5, 7, and 8. Synthetic image 1215 is an example of, or includes aspects of, the corresponding element described with reference to FIGS. 3-5, and 8.

### Training and Evaluation

In FIG. 13, a method, apparatus, non-transitory computer readable medium, and system for image processing include obtaining a training set including a training text prompt, a training text response, a training input image, and a training output image. An aspect further includes training, using the training set, a language generation model to generate a text response and a guidance embedding based on an input text prompt and an input image. An aspect further includes training, using the training set, an image generation model to generate a synthetic image based on the input image and the guidance embedding.

Some examples of the method, apparatus, non-transitory computer readable medium, and system further include calculating a language loss including a first term based on the training text response and a second term based on the training output image, where the language generation model is trained based on the language loss. Some examples of the method, apparatus, non-transitory computer readable medium, and system further include computing an image loss based on the training output image and the training input image, where the image generation model is trained based on the image loss.

Some examples of the method, apparatus, non-transitory computer readable medium, and system further include adding noise to the training output image to obtain a noisy image. Some examples further include performing a reverse diffusion process on the noisy image using the image generation model. Some examples of the method, apparatus, non-transitory computer readable medium, and system further include generating, using a training image generation model, the training output image based on the training input image.

Some examples of the method, apparatus, non-transitory computer readable medium, and system further include obtaining a plurality of preliminary images. Some examples further include filtering the plurality of preliminary images based on the training output image to obtain the training input image.

Some examples of the method, apparatus, non-transitory computer readable medium, and system further include generating, using a training language generation model, the training text prompt based on the training input image. Some examples further include generating, using the training language generation model, the training text response based on the training text prompt.

Some examples of the method, apparatus, non-transitory computer readable medium, and system further include obtaining a reference image. Some examples further include generating a plurality of training output images based on the training input image and the reference image, where the training set includes the plurality of training output images.

FIG. 13 shows an example of a method 1300 for training the machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system obtains a training set including a training text prompt, a training text response, a training input image, and a training output image. In some cases, the operations of this step refer to, or may be performed by, a training component as described with reference to FIG. 7. According to some aspects, a data preparation component (e.g., described with reference to FIG. 7) obtains a plurality of preliminary images and filters the plurality of preliminary images based on the training output image to obtain the training input image. In some aspects, a training image generation model (e.g., the training image generation model described with reference to FIG. 7) generates the training output image based on the training input image. In some aspects, a training language generation model (e.g., the training language generation model described with reference to FIG. 7) generates the training text prompt based on the training input image and generates the training text response based on the training text prompt.

For example, the data preparation component obtains a preliminary training set including a plurality of images and a plurality of instructions (e.g., text prompts). Then, the training image generation model is used to generate preliminary synthetic images based on randomly selecting an input image from the plurality of images and a text prompt from the plurality of instructions. In some cases, for example, the training image generation model is ProFusion.

The preliminary synthetic images are automatically filtered based on a CLIP similarity score and a DINO similarity score. For example, the data preparation component computes the CLIP similarity score (for example, using a pre-trained CLIP ViT-B/32 model) that measures the similarity of image-text prompt pairs. Images having a CLIP similarity score of less than 0.3 are filtered and removed from the preliminary training set. Additionally, the data preparation component computes the DINO similarity score (for example, using a pre-trained DINO Vit-S/16 model) that measures the similarity between the input image and the preliminary synthetic image. Images having a DINO similarity score of less than 0.6 are filtered and removed from the preliminary training set. Accordingly, the synthetic image includes at least one element described by the text prompt and the contents of the input image. In some cases, the identity of an object in the synthetic image is preserved based on the filtering.

In some cases, the preliminary synthetic images are further filtered by human evaluators. For example, the data preparation component provides the input image, the corresponding text prompt, and the preliminary synthetic image to the human evaluator. The human evaluator filters and removes low-quality images that are not aligned with the text prompt or images in which the identity is not preserved.

In some cases, the training language model is used to generate text responses based on the text prompts. The text responses and the text prompts are used in the training set to simulate an interaction between a user and an assistant model. Accordingly, the training set includes the training text prompt, training text response, training input image, and training output image.

At operation 1310, the system trains, using the training set, a language generation model to generate a text response and a guidance embedding based on an input text prompt and an input image. In some cases, the operations of this step refer to, or may be performed by, a training component as described with reference to FIG. 7. According to some aspects, the training component calculates a language loss including a first term based on the training text response and a second term based on the training output image. The language generation model is trained based on the language loss.

In some cases, \tilde{x} represents the training output image, x represents the input image, and \tilde{y} represents the training text response, and y represents the input text prompt. In some embodiments, the language generation model can be trained using the following loss:

$${ℒ}_{ℳ} = {ℒ}_{L ℳ} ( ℳ ( y ) , \tilde{y} ) + λ d ( H ( s ) , ℱ ( \tilde{x} ) ) , \qquad ( 5 )$$

where [symbol] _{LM} represents the language model loss, [symbol] (y) represents text response generated by the language model, [symbol] (\tilde{x}) represents image embedding (e.g., CLIP image global embedding) of synthetic image \tilde{x}, d(⋅,⋅) calculates the difference between two vectors, and λ>0 is a hyper-parameter. In some embodiments, d(⋅,⋅) is a mean squared error. In some embodiments, the hyper-parameter is set to λ=0.2.

According to some embodiments, the entire language generation model is trained. According to some embodiments, the image projection layer and the guidance projection layer of the language generation model are trained. By training projection layers of the language generation model instead of the entire language generation model, the training cost and computational resources can be reduced. For example, the image projection layer is trained to transform an image embedding of the input image to obtain a projected image embedding. In some cases, the training projection layer is trained to transform an embedding in a high-dimensional vector space into an embedding in a low-dimensional vector space. The guidance projection layer is trained to transform an output embedding of the language generation model to obtain a guidance embedding. For example, the guidance projection layer is trained to transform an embedding in a low-dimensional vector space into an embedding in a high-dimensional vector space.

At operation 1315, the system trains, using the training set, an image generation model to generate a synthetic image based on the input image and the guidance embedding. In some cases, the operations of this step refer to, or may be performed by, a training component as described with reference to FIG. 7. In some aspects, the training component computes an image loss based on the training output image and the training input image, where the image generation model is trained based on the image loss. In some aspects, the image generation model adds noise to the training output image to obtain a noisy image and performs a reverse diffusion process on the noisy image.

In one aspect, [symbol] (\tilde{x}) represents a CLIP image embedding. By training the machine learning model using the CLIP image embedding [symbol] (\tilde{x}), the machine learning model improves on conventional models by reducing training time and providing additional flexibilities. For example, by using the CLIP image embedding, for example, generated from a training image encoder, the language generation model and the image generation model can be trained separately. In some cases, the language generation model and the image generation model have billions of parameters, and joint training can be computationally burdensome. Additionally, the machine learning model can have flexible generations. According the image generation model can be trained as follows:

$${ℒ}_{𝒢} = 𝔼 [ {‖ ϵ - {ϵ}_{θ} ( ℱ ( \tilde{x} ) ) , ℰ ( x ) , {\tilde{x}}_{t} ‖}^{2} ] , \qquad ( 6 )$$

where ϵ˜ [symbol] (0, I) represents randomly sampled noise, and \tilde{x}ₜ represents noised samples (e.g., the noised samples in the diffusion model described with reference to FIG. 9).

Alternatively, for example, the machine learning model can use image embedding of a reference image w as semantics to guide the image generation model as \tilde{x}= [symbol] ( [symbol] (x), [symbol] (w)). In some embodiments, the filtered images are used to generate training output images using the machine learning model of the present disclosure. For example, the training output images can be generated by equation (4).

### Computing Device

FIG. 14 shows an example of a computing device 1400 according to aspects of the present disclosure. The example shown includes computing device 1400, processor 1405, memory subsystem 1410, communication interface 1415, I/O interface 1420, user interface component 1425, and channel 1430.

In some embodiments, computing device 1400 is an example of, or includes aspects of, the image processing apparatus described with reference to FIGS. 1 and 7. In some embodiments, computing device 1400 includes processor 1405 that can execute instructions stored in memory subsystem 1410 to obtain an input image and a text prompt. The instructions further include to generate, using a language generation model, a text response based on the input image and the text prompt, where the text response describes a modification to the input image. The instructions further include to generate, using an image generation model, a synthetic image based on the input image and an output embedding of the language generation model, where the synthetic image depicts the modification to the input image.

According to some embodiments, processor 1405 includes one or more processors. In some cases, processor 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1405 is configured to operate a memory array using a memory controller. In other cases, a memory controller is integrated into processor 1405. In some cases, processor 1405 is configured to execute computer-readable instructions stored in a memory to perform various functions. In some embodiments, processor 1405 includes special-purpose components for modem processing, baseband processing, digital signal processing, or transmission processing. Processor 1405 is an example of, or includes aspects of, the processor unit described with reference to FIG. 7.

According to some embodiments, memory subsystem 1410 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1410 is an example of, or includes aspects of, the memory unit described with reference to FIG. 7.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1415.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or hardware components controlled by the I/O controller. I/O interface 1420 is an example of, or includes aspects of, the I/O module described with reference to FIG. 7.

According to some embodiments, user interface component 1425 enables a user to interact with computing device 1400. In some cases, user interface component 1425 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over existing technology (e.g., conventional image generation models). Example experiments demonstrate that the image processing apparatus based on the present disclosure outperforms conventional image generation models. Details on the example use cases based on embodiments of the present disclosure are described with reference to FIGS. 3, 4, and 5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and a text prompt comprising an image modification request;
generating, using a language generation model, a text response based on the input image and the text prompt, wherein the text response describes a modification to the input image corresponding to the input modification request; and
generating, using an image generation model, a synthetic image based on the input image and an output embedding of the language generation model, wherein the synthetic image depicts the modification to the input image.

2. The method of claim 1, wherein generating the synthetic image comprises:
encoding, using an image encoder, the input image to obtain an image embedding, wherein the synthetic image is generated based on the image embedding.

3. The method of claim 2, further comprising:
transforming, using an image projection layer of the language generation model, the image embedding to obtain a projected image embedding, wherein the text response and the output embedding are based on the projected image embedding.

4. The method of claim 1, wherein generating the synthetic image comprises:
transforming, using a guidance projection layer of the language generation model, the output embedding of the language generation model to obtain a guidance embedding, wherein the synthetic image is generated based on the guidance embedding.

5. The method of claim 1, wherein generating the synthetic image comprises:
obtaining a reference image, wherein the synthetic image is generated based on the reference image.

6. The method of claim 5, further comprising:
generating a plurality of images by iteratively adjusting a parameter that balances the input image and the reference image.

7. The method of claim 1, wherein:
the language generation model is trained to generate a guidance embedding for the image generation model; and
the image generation model is trained to generate the synthetic image based on the guidance embedding.

8. A method comprising:
obtaining a training set including a training text prompt, a training text response, a training input image, and a training output image;
training, using the training set, a language generation model to generate a text response and a guidance embedding based on an input text prompt and an input image; and
training, using the training set, an image generation model to generate a synthetic image based on the input image and the guidance embedding.

9. The method of claim 8, wherein training the language generation model comprises:
calculating a language loss including a first term based on the training text response and a second term based on the training output image, wherein the language generation model is trained based on the language loss.

10. The method of claim 8, wherein training the image generation model comprises:
computing an image loss based on the training output image and the training input image, wherein the image generation model is trained based on the image loss.

11. The method of claim 8, wherein training the image generation model comprises:
adding noise to the training output image to obtain a noisy image; and
performing a reverse diffusion process on the noisy image using the image generation model.

12. The method of claim 8, wherein obtaining the training set comprises:
generating, using a training image generation model, the training output image based on the training input image.

13. The method of claim 8, wherein obtaining the training set comprises:
obtaining a plurality of preliminary images; and
filtering the plurality of preliminary images based on the training output image to obtain the training input image.

14. The method of claim 8, wherein obtaining the training set comprises:
generating, using a training language generation model, the training text prompt based on the training input image; and
generating, using the training language generation model, the training text response based on the training text prompt.

15. The method of claim 8, further comprises:
obtaining a reference image; and
generating a plurality of training output images based on the training input image and the reference image, wherein the training set includes the plurality of training output images.

16. An apparatus comprising:
at least one processor;
at least one memory storing instructions executable by the at least one processor;
a language generation model comprising parameters stored in the at least one memory and trained to generate a text response based on an input image and a text prompt; and
an image generation model comprising parameters stored in the at least one memory and trained to generate a synthetic image based on the input image and an output embedding of the language generation model.

17. The apparatus of claim 16, further comprising:
an image encoder comprising parameters stored in the at least one memory and configured to encode the input image to obtain an image embedding.

18. The apparatus of claim 16, further comprising:
an image projection layer comprising parameters stored in the at least one memory and configured to transform an image embedding of the input image to obtain a projected image embedding.

19. The apparatus of claim 16, further comprising:
a guidance projection layer comprising parameters stored in the at least one memory and configured to transform the output embedding of the language generation model to obtain a guidance embedding.

20. The apparatus of claim 16, wherein:
the image generation model comprises a diffusion model.
